(19) United States
(12) Patent Application Publication
(10) Pub. No.: US 2008/0304138 A1
(43) Pub. Date: Dec. 11, 2008

(54) Optical Amplifier Comprising a Pump Module

(76) Inventor: Peter Krummrich, Munchen (DE)

Correspondence Address: BELL, BOYD & LLOYD, LLP, P.O. BOX 1135, CHICAGO, IL, 60690, US

(21) Appl. No.: 11/632,901

(22) PCT Filed: Jul. 12, 2005
(86) PCT No.: PCT/EP05/53322

§ 371 Date: Jan. 19, 2007

(30) Foreign Application Priority Data
Jul. 23, 2004 (DE) 10 2004 035795.1

(51) Int. Cl. H01S 3/09; H04B 10/12; H01S 3/14

(52) U.S. Cl. 359/341.32; 359/341.5

(57) ABSTRACT

In one aspect, an optical amplifier including a pump module, preferably for amplifying channels of a WDM-signal is provided. The outlet thereof is connected to an amplifying fibre wherein signal radiation formed by optical signals is amplified. In order to amplify the optical signals with minimum gain spectrum difference, i.e. in the WDM-technique with minimal channel level differences, pump radiation emerging from the pump module has a mode field diameter in the amplification fibre which is selected so that it is smaller than a mode field diameter of the signal radiation.

### CROSS REFERENCE TO RELATED APPLICATIONS

This application is the US National Stage of International Application No. PCT/EP2005/053322, filed Jul. 12, 2005 and claims the benefit thereof. The International Application claims the benefits of German application No. 102004035795.1 DE filed Jul. 23, 2004, both of the applications are incorporated by reference herein in their entirety.

### FIELD OF INVENTION

The invention relates to an optical amplifier comprising a pump module.

### BACKGROUND OF INVENTION

The rapid growth in the internet has caused a brisk increase in the amount of data traffic. For the network providers wavelength division multiplexing (WDM) has proved to be a suitable technology for providing the corresponding transmission capacity. The data traffic also makes increased demands on the flexibility of the network in addition to the greater capacity requirement. The traffic relationships and the required capacity per connection change more frequently and more markedly in data networks than in networks which primarily transmit voice traffic.

### SUMMARY OF INVENTION

To increase flexibility the network providers would like optical networks which they can dynamically adapt to a change in the amount of data traffic. The preferred solution lies in a transparent network of intermeshed WDM sections. Individual channels or wavelengths should in the process preferably be transmitted in a transparent manner from source node to target node.

Frequent reconfiguration of the network is accompanied by constantly changing channel loadings of optical WDM signals in the optical amplifiers. The amplifiers have to be capable of processing any desired combination of active channels with different wavelengths up to a maximum given number.

To be able to provide the high total transmitting powers required in the case of maximum channel loading, optical amplifiers are typically operated in saturation mode. In this operating state the transmitting power of a channel in the case of constant pumping level depends on how many of the other channels are active—i.e. not switched off. With homogeneous line broadening the transmitting power of remaining channels may be kept constant in that the pumping level is adjusted with the aid of control of the number of active channels. Homogenous line broadening results in a gain spectrum with constant form which is fully established by the gain in the case of an individual wavelength.

In the erbium-doped amplifiers usually used nowadays, as in the case of most other amplifiers with active laser ions from the group of rare earths, inhomogeneous line broadening occurs in addition to homogenous line broadening. Inhomogeneous line broadening leads to a gain spectrum, of which the form depends on the exact wavelengths and powers of the active channels. For example switching one channel off leads to a greater increase in the gain of the adjacent channels than the gain in the channels that are further removed in the wavelength range. Conversely, switching a channel on reduces the gain in the channels more markedly in the case of adjacent wavelengths than in the case of more remote wavelengths. The added channel burns, as it were, a hole in the gain spectrum (spectral hole burning, abbreviated to SHB).

Using a pumping level control system it is possible to adjust only the mean amplifier gain. Changes in the gain spectrum form result in efficiency variances in the remaining channels at the amplifier outlet. These efficiency variances are superimposed on each other from amplifier to amplifier and with long transmission systems with many sections can lead to inadmissibly high channel level differences.

Up to now approaches have been known from the literature, which compensate the channel level differences that occur outside of the optical amplifiers or between amplification stages. Passive optical filters can be used for this purpose which allow the power of an individual channel or small group of channels to be damped by an adjustable amount. Control of the filter usually requires measurement of the channel level distribution using an optical spectrum analyzer or an arrangement with comparable functionality. Using the measured level distribution, filter coefficients may then be adjusted such that channel level differences that are as small as possible occur downstream of the filter or at the amplifier outlet. The described method is very complex and works with very expensive components. With multiple cascading of filters, damping of the power of individual channels may also lead to inadmissible constriction of the signal bandwidth.

An object of the invention is to disclose an optical amplifier with a pump module which allows amplification of optical signals with minimal gain spectrum differences.

A method is sought which reduces channel level differences, for example in the case of a WDM signal as a result of inhomogeneous line broadening of the optical amplifiers with changing combinations of active channels, or keeps them below admissible limits.

One solution to the object takes place by way of an optical amplifier with the features of the independent claims.

Starting from an optical amplifier with a pump module, of which the outlet is connected to an amplifying fiber, in which signal radiation formed by optical signals is amplified, according to the invention pump radiation emerging from the pump module has a mode field diameter in the amplifying fiber which is smaller than a mode field diameter of the signal radiation.

A fundamental advantage of the method according to the invention may be seen in that, as a result of this special configuration of the optical amplifier, there is weaker burning of holes into the gain spectrum, and this leads to lower channel level differences, in particular in the case of changing channel loadings.

Different embodiments, inter alia as a result of wavelength spacing between pump and signal or adjusted refractive index profiles of the amplifying fibers, etc., are described to achieve this advantage. Advantageous developments of the invention are disclosed in the dependent claims in this regard.

### BRIEF DESCRIPTION OF THE DRAWINGS

One exemplary embodiment of the invention will be described in more detail hereinafter with reference to the drawings, in which:

FIGS. 1a, 1b and 1c show graphs of a refractive index, doping and an intensity profile of signals in the case of an amplifying fiber cross-section,

FIG. 2 shows a refractive index profile of the cross-section of the amplifying fiber.

### DETAILED DESCRIPTION OF INVENTION

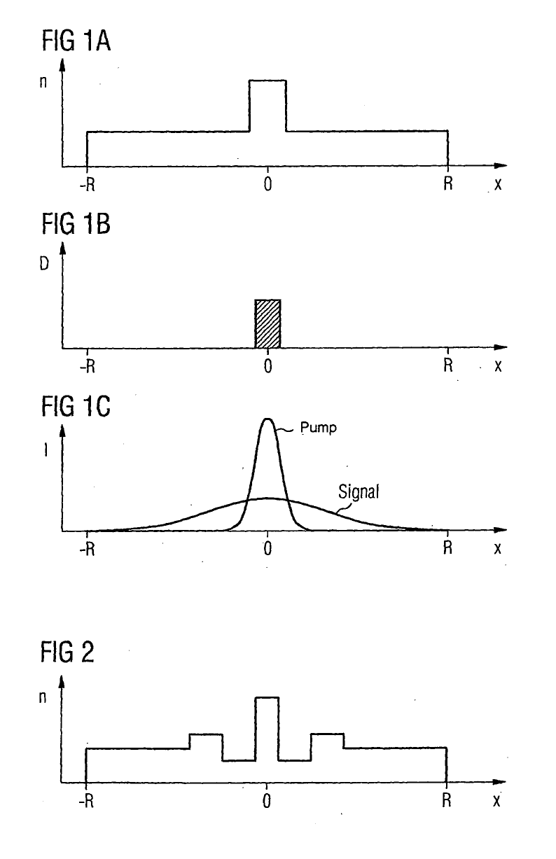

The proposed concept according to the invention avoids channel level differences in the case of changing channel loading by reducing the burning of holes into the gain spectrum of optical amplifiers. FIGS. 1a, 1b and 1c will be considered to describe the concept. The upper graph 1a shows the characteristic of the refractive index n in the active fiber—amplifying fiber with known core and cladding parts—over a space coordinate x=−R, 0, +R perpendicular to the fiber axis, i.e. transversal. The refractive index profile is used to guide the pump radiation and signal radiation in the active fiber and has a concentric and stepped characteristic centered around the fiber axis. The refractive index of the core glass—in the region of the space coordinate 0—lies above the refractive index of a cladding glass—region of the space coordinates −R to +R—which surrounds the core.

The central graph 1b illustrates doping D of the glass with erbium ions over the transversal space coordinate −R, 0, +R according to graph 1a. In the chosen example the doped region extends over only part of the fiber core.

The lower graph 1c illustrates the intensity characteristics I of the pump radiation and signal radiation pump, signal over the transversal space coordinate−R, 0, +R according to graph 1a. With conventionally configured amplifiers the level characteristics have a form that is optimally similar, i.e. mode field diameters should differ from each other as little as possible. An overlapping integral in the two field distributions should be as close to “1” as possible. With the optical amplifier according to the invention the signal radiation has a much larger mode field diameter than the pump radiation. Consequently the high intensity of the pump radiation at a given power leads to a strong inversion of the population density of the erbium ions. The high inversion results in a high amplification per length of amplification fiber and in good noise properties. Owing to the large mode field diameter in the case of a signal wavelength the signal radiation at a given power has a much lower intensity. The lower intensity results, even in the case of maximum transmitting power, in a dominance of the spontaneous transitions of the erbium ions from the upper to the lower laser level with respect to the transitions stimulated by signal radiation. The dominance of the spontaneous transitions through to maximum power in the active fiber reduces the effect of saturation and therewith burning of holes into the gain spectrum.

The lower amplification per length than in the case of conventional amplifier design may be compensated by a higher concentration of erbium ions or by a longer active fiber.

A much larger mode field diameter in the case of the signal wavelength than in the pump wavelength may be attained by selecting pump and signal wavelengths that are widely separated (980 nm pump wavelength instead of 1480 nm with a 1550 nm signal wavelength) and by way of a strong waveguide dispersion or a host glass with strong material dispersion. Either a stepped profile with high numerical aperture and small core diameter according to FIGS;. 1a, 1b and 1c or an annular profile according to FIG. 2, which, in addition to the central core region with a high refractive index, comprises further transversal concentric rings with a slightly increased or reduced refractive index compared with the outer cladding, is suitable for a strong waveguide dispersion. FIG. 2 shows an example of a ring profile of this type.

As a size for a clear reduction in the saturation and burning of holes into the gain spectrum, the mode field diameter in the case of the signal wavelength should be selected so as to be at least twice as large as the mode field diameter of the pump wavelength. Furthermore the minimum mode field diameter of the pump radiation should be selected so as to be only slightly larger than the diameter of the region doped with erbium ions around the fiber axis.

In FIG. 2 the diameter of the inner core is 4 μm; the refractive index n is selected to be as high as possible. The refractive indices and diameters of the two rings are selected such that the active fiber still guides the pump radiation at 980 nm in a single mode manner and the mode field diameter of the signal radiation at 1550 nm is higher by a factor of 2.5 than the mode field diameter in the case of the pump wavelength.

1-6. (canceled)

7. An optical amplifier, comprising:
a pump module, of which an outlet is connected to an amplifying fiber, in which a signal radiation formed by optical signals is amplified, wherein the amplifying fiber is constructed such that a mode field diameter of a signal radiation is at least twice as large as a mode field diameter of a pump radiation given off by the pump module, such that the intensity of the signal radiation is reduced in the amplifying fiber such that the effect of a spectral hole burning is reduced.

8. The optical amplifier as claimed in claim 7, wherein the pump and the signal radiation have a greatest possible wavelength spacing, so the mode field diameter of the pump radiation is smaller by at least substantially a factor of two compared with the mode field diameter of the signal radiation.

9. The optical amplifier as claimed in claim 7, wherein a transversal refractive index profile of the amplifying fiber is selected such that a waveguide dispersion is formed in which the mode field diameter of the pump radiation is smaller by at least substantially a factor of two compared with the mode field diameter of the signal radiation.

10. The optical amplifier as claimed in claim 7, wherein the amplifying fiber has a transversal refractive index stepped profile with a high numerical aperture and small core diameter.

11. The optical amplifier as claimed in claim 7, wherein the amplifying fiber has a transversal refractive index stepped profile that comprises a concentric annular profile with a refractive index that is increased or reduced compared with an outer cladding.

12. The optical amplifier as claimed in claim 7, wherein the amplifying fiber has a transversal, concentric region doped with erbium, of which the diameter is at most as large as the mode field diameter of the pump radiation, with the pump radiation being guided in a single-mode manner.
